(19) United States
(12) Patent Application Publication
(10) Pub. No.: US 2014/0103106 A1
(43) Pub. Date: Apr. 17, 2014

(54) SYSTEM FOR DISPLAYING SERVICE INFORMATION

(71) Applicant: Samuel Patrick Stewart, Montclair, NJ (US)

(72) Inventor: Samuel Patrick Stewart, Montclair, NJ (US)

(21) Appl. No.: 13/859,322

(22) Filed: Apr. 9, 2013

Related U.S. Application Data
(60) Provisional application No. 61/715,087, filed on Oct. 17, 2012.

(51) Int. Cl. G06F 17/30

(52) U.S. Cl. CPC G06F 17/30879
USPC 235/375

(57) ABSTRACT

A system for displaying information about a service. The system for displaying information about a service may include a database server that hosts a web page. The web page may display the digital version of information about the service. A QR code may be created to link a user to the web page. A user with a computer that has a QR code reading program may scan the QR code, which links to the web page displaying the digital version of the service onto the screen of the computer.

### BACKGROUND OF THE INVENTION

The present invention relates to providing information about a service and, more particularly, to a system for digitally displaying information about a service and replacing programs.

When an individual dies, family and friends want to refer to personalized memorial keepsakes about that particular individual. Further, people are interested in information about the deceased individual and about the final services. This type of information may be desirable during the services as well as after the service is complete.

Currently, hard copies of memorial keepsakes are produced on poster boards and the like to be displayed during services as well as handed out to visitors as programs for the services. The hard copies create waste and occasionally not enough copies are produced for all of the people that attend the service. Limitations are also placed on the information that can be included on the program because of the size of the physical resources that one has to work with, as well as limitations due to costs to produce hard copies for a large number of people. Another limitation with hard copies is that the programs are only available to the people that attended the service.

As can be seen, there is a need for a system that digitally displays information about a service that allows for larger quantities of information to be disseminated to a larger group of people, costs less than what is currently provided and is not as wasteful.

### SUMMARY OF THE INVENTION

In one aspect of the present invention, a system for displaying information about a deceased individual comprises: a database server comprising stored data comprising a digital version of memorial information about the deceased individual; and a computer comprising a quick reference code reader program, wherein said computer scans a quick reference code using said quick reference code reader program, wherein said quick reference code links said computer to said stored data on said database server.

In another aspect of the present invention, a method for displaying information about a deceased individual comprises the steps of: producing a data comprising a digital version of memorial information about the deceased individual; uploading said data to a database server; generating a quick reference code linked to said data on said database server; displaying said quick reference code; scanning said quick reference code using a quick reference code program on a computer; and producing said memorial information on said computer.

These and other features, aspects and advantages of the present invention will become better understood with reference to the following drawings, description and claims.

### BRIEF DESCRIPTION OF THE DRAWINGS

FIG. 1 is a schematic view of a system for digitally displaying information on a deceased individual according to an exemplary embodiment of the present invention;

FIG. 2 is a perspective view of the present invention shown in exemplary use; and

FIG. 3 is a perspective view of an alternate embodiment of the present invention.

### DETAILED DESCRIPTION OF THE INVENTION

The following detailed description is of the best currently contemplated modes of carrying out exemplary embodiments of the invention. The description is not to be taken in a limiting sense, but is made merely for the purpose of illustrating the general principles of the invention, since the scope of the invention is best defined by the appended claims.

Broadly, an embodiment of the present invention provides a system for displaying information about a service. The system for displaying information about a service may include a database server that hosts a web page. The web page may display the digital version of information about the service. A QR code may be created to link a user to the web page. A user with a computer that has a QR code reading program may scan the QR code, which links to the web page displaying the digital version of the service onto the screen of the computer.

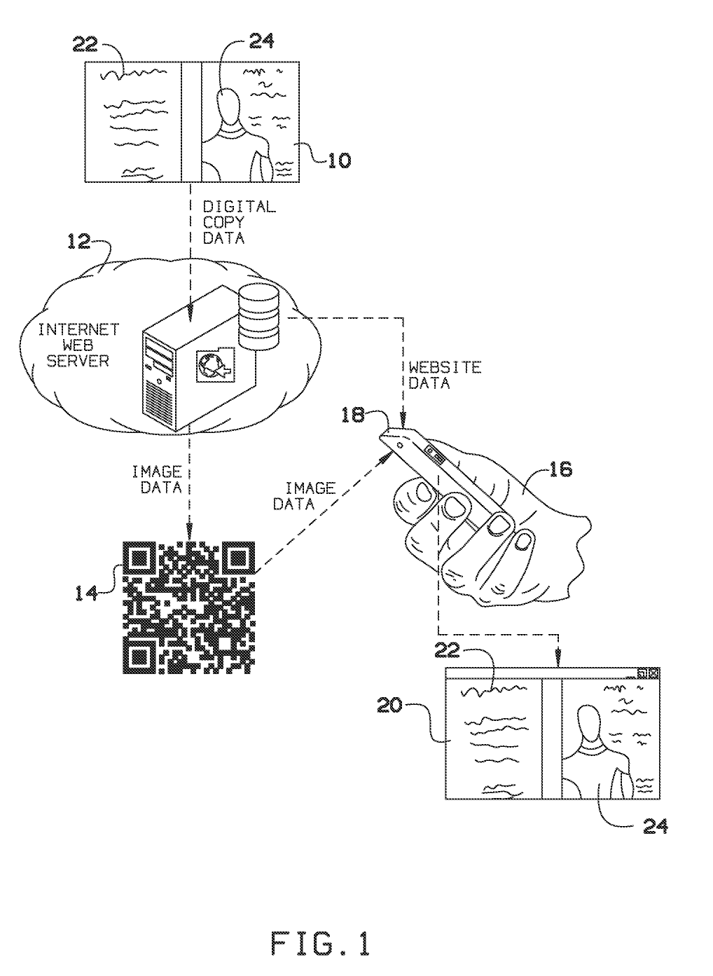

Referring to FIG. 1 through 4, the system for displaying information about a service may include a digital version of the information 10. This digital version of the information 10 may include text 22, such as a message, and it may include an image or images 24. The digital version of information 10 may be in the form of data. The data may be uploaded to a database server, such as an internet web server 12.

In certain embodiments, the service may include a funeral service. A QR code 14 may be generated that directly refers to the data that may display information about the deceased 20. A user 16 may use a smartphone 18 with a QR code reader software program, or some other device, such as a tablet or laptop. The QR reader program scans the QR code 14, which then links the device to the data that may display information about the deceased 20, which may be displayed on a web page. The smartphone 18 may then display the digital version of memorial information 10 to the user 16.

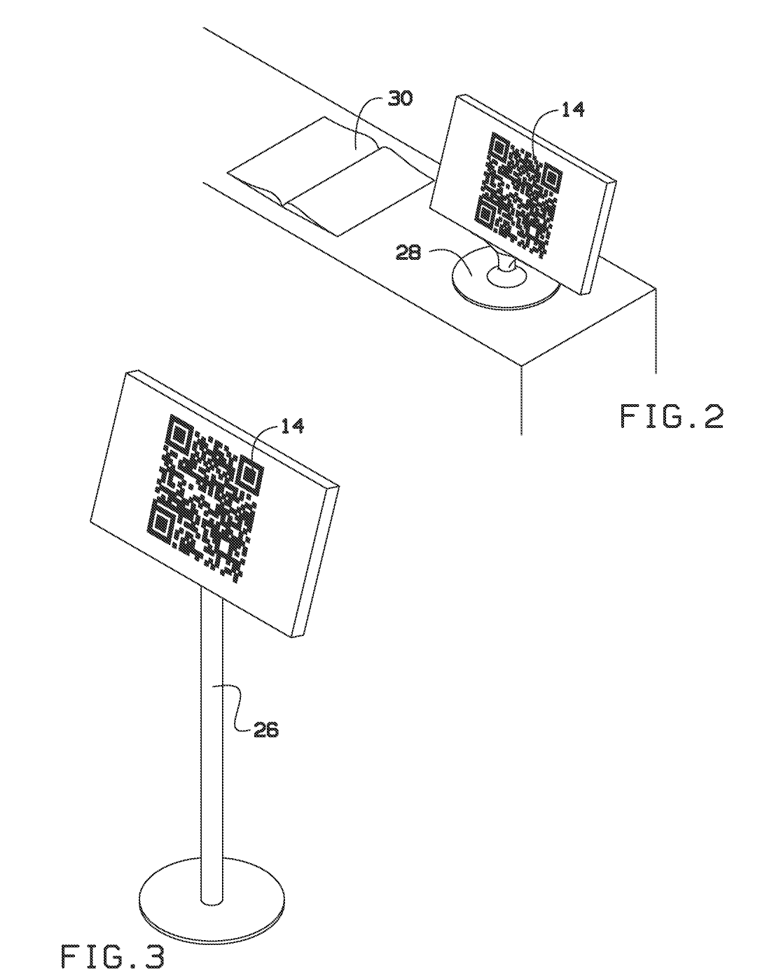

In certain embodiments, the QR code 14 may be displayed on an item. As is illustrated in FIG. 2 and FIG. 3, there may be a location where visitors may sign in using a register book 30 during or prior to a funeral. In certain embodiments, this may be an example of the item that displays the QR code 14. The item may be a short stand 28, which may be used in order to display the QR code 14 beside the register book 30, or a long stand 26 may be used as a visitor is walking in, that may display the QR code 14 appropriately. In certain embodiments, the QR code 14 may be displayed on a digital screen.

It is further contemplated that the present invention may be used for a play to bring up a program for the play, or the present invention may be used at a wedding to bring up programs or keepsake items for the wedding, or used at a church service to bring up the bulletin for the church service. In certain embodiments, a visitor to a wake service, funeral service, or the like may easily view the memorial information available by using a smartphone or other device with any one of the several QR reader applications that may be installed.

A method for displaying information about a program of a service may include the steps of: producing a data comprising a digital version of the information about the service; uploading the data to a database server; generating a quick reference code linked to the data on the database server; displaying the quick reference code; scanning the quick reference code using a quick reference code program on a computer; and producing the service information on the computer.

The computer-based data process system and method described above is for purposes of example only, and may be implemented in any type of computer program, alone or in conjunction with hardware. The present invention may also be implemented in software stored on a computer-readable medium and executed as a computer program on a general purpose or special purpose computer. For clarity, only those aspects of the system germane to the invention are described, and product details well known in the art are omitted. For the same reason, the computer hardware is not described in further detail. It should thus be understood that the invention is not limited to any specific computer language, program, or computer. It is further contemplated that the present invention may be run on a stand-alone computer system, or may be run from a server computer system that can be accessed by a plurality of client computer systems interconnected over an intranet network, or that is accessible to clients over the Internet. In addition, many embodiments of the present invention have application to a wide range of industries. To the extent the present application discloses a system, the method implemented by that system, as well as software stored on a computer-readable medium and executed as a computer program to perform the method on a general purpose or special purpose computer, are within the scope of the present invention. Further, to the extent the present application discloses a method, a system of apparatuses configured to implement the method are within the scope of the present invention.

It should be understood, of course, that the foregoing relates to exemplary embodiments of the invention and that modifications may be made without departing from the spirit and scope of the invention as set forth in the following claims.

What is claimed is:

1. A system for displaying information about a service comprising:
a database server comprising stored data comprising a digital version of information about said service representing a program for said service; and;
a computer comprising a quick reference code reader program, wherein said computer scans a quick reference code using said quick reference code reader program, wherein said quick reference code links said computer to said stored data on said database server.

2. The system of claim 1, wherein said service comprises a funeral service, wedding service, a church service, or a play.

3. The system of claim 1, wherein said quick reference code links said computer to said stored data on said database using the internet.

4. The system of claim 3, wherein said data is displayed on said computer on a web page.

5. The system of claim 1, further comprising a single item displaying said quick reference code.

6. The system of claim 1, wherein said single item is a stand.

7. The system of claim 1, wherein said computer is a smart device.

8. The system of claim 7, wherein said quick reference code reader is an application on said smart device.

9. The system of claim 8, wherein said smart device is a smart phone.

10. The system of claim 2, wherein said program is a program of a funeral service.

11. The system of claim 10, wherein said digital version of said program comprises at least one of a picture of a deceased individual and text describing said deceased individual.

12. A method for displaying information about a program of a service comprising the steps of:
producing a data comprising a digital version of said information about said service;
uploading said data to a database server;
generating a quick reference code linked to said data on said database server;
displaying said quick reference code;
scanning said quick reference code using a quick reference code program on a computer; and
producing said service information on said computer.

13. The method of claim 12, wherein said computer is a smart device.

14. The method of claim 13, wherein said smart device is a smart phone.
